(19) United States
(12) Patent Application Publication
(10) Pub. No.: US 2007/0158477 A1
(43) Pub. Date: Jul. 12, 2007

(54) Spraying device

(75) Inventors: Chou-Lin Wu, Hsinchu Hsien (TW); Chi-Ming Huang, Hsinchu (TW); Chun-Fu Lu, Hsinchu (TW); Chun-Jung Chen, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/594,180

(22) Filed: Nov. 8, 2006

(30) Foreign Application Priority Data
Dec. 30, 2005 (TW) 094147459

(51) Int. Cl. B05B 1/34; A62C 31/02; B05B 1/00

(52) U.S. Cl. 239/589; 239/533.14; 239/596; 239/598

(57) ABSTRACT

A spraying device for atomizing a liquid is proposed. The spraying device includes a nozzle plate and an actuator. The nozzle plate is provided with a plurality of nozzle apertures. Each of the nozzle apertures includes an entry end for the liquid to enter and an exit end for the liquid to exit. The entry end and the exit end of at least one of the nozzle apertures are asymmetrical structures. The actuator is integrated with the nozzle plate to actuate atomization of the liquid. The spraying direction of a liquid droplet after the liquid is atomized can be controlled by modifying the shape of the exit end of the nozzle aperture.

### FIELD OF THE INVENTION

The present invention relates to a liquid atomizing technique, and more particularly, to a spraying device.

### BACKGROUND OF THE INVENTION

With rapid advances in technology, the scope of application of technology that utilizes an atomizing system to carry out liquid atomization is becoming broader. The atomization principle has been used in the applications such as a spraying device of a drug delivery system utilized in biomedical science, a fuel-injection atomizing system required for providing engine combustion, and a beat dissipating cooling system that achieves a cooling effect by means of a liquid phase-change. The relevant techniques have been disclosed in the U.S. Pat. No. 4,465,234, the U.S. Pat. No. 4,605,167, the U.S. Pat. No. 6,089,698, the U.S. Pat. No. 6,235,177, the U.S. Pat. No. 6,629,646, Taiwanese Patent No. 407529, Taiwanese Patent No. 449486, Taiwanese Patent No. 503129, Taiwanese Patent No. 506855, Taiwanese Patent No. 562704, and Taiwanese Patent Certificate No. I222899.

Referring to FIG. 7, an existing spraying device comprises a piezoelectric actuator 10 functioning as a vibrator and a nozzle plate 20 having a plurality of nozzle apertures 201. The nozzle plate 20 is in direct contact with a liquid 3 to be atomized. Under an applied voltage, the piezoelectric actuator 10 oscillates the liquid 3, such that the liquid 3 is sprayed out of the nozzle plate 20 through the nozzle apertures 201, thus achieving an atomization effect. U.S. Pat. No. 6,629,646 discloses a basic structure of a spraying device that utilizes the piezoelectric actuator.

Referring to FIG. 8a to FIG. 8c, the nozzle apertures 201 of the nozzle plate 20 of a conventional spraying device are mostly designed to have symmetrical geometric shapes. As the liquid 3 is ejected from the device in a direction perpendicular to the surface of the nozzle plate 20, a spraying area is restricted by the location and the distribution area of the nozzle apertures. In other words, an atomization effect is limited to the area corresponding to the nozzle apertures 201. Therefore, an atomizing area is typically small as a result, which adversely affects the atomization effect.

Furthermore, due to the extreme narrowness of the atomizing area, atomized liquid droplets can collide with each other and accumulate. This not only increases the size of the atomized liquid droplets but also causes a poor atomization effect. Moreover, if the atomizing area is to be modified, the distribution area of the nozzle apertures has to be modified correspondingly or the actuating frequency has to be modulated correspondingly, thus inevitably increasing the volume of the system. Additionally, large-scale actuation requires a higher resonance form and therefore consumes more energy.

Owing to limited energy resources and the miniaturization requirement for various products nowadays, achieving the best atomization effect with the least energy resources within a limited volume is imperative. Therefore, the forgoing technique does not satisfy the practical demand as it consumes more energy and does not meet the miniaturization requirement due to its bulkiness.

U.S. Pat. No. 4,465,234 discloses a spraying device designed to increase the atomizing area by modifying a geometric shape of a nozzle plate. The spraying device comprises a nozzle plate having a pressurization cavity for containing a liquid; a nozzle base mounted on the nozzle plate for communicating with the pressurization cavity; an electric vibrator mounted on the nozzle plate for periodically applying voltages to the liquid; an injecting tool for injecting and maintaining the liquid in the pressurization cavity; a tool for applying alternating currents to the electric vibrator; and a tool for combining the injecting tool to expel the liquid. When the liquid in the pressurization cavity is expelled out in the form of atomized liquid droplets after the voltage has been applied, the atomizing area can be increased by the nozzle plate having arc-shaped nozzle apertures. However, as the fabrication method of the nozzle plate is very complicated, the patent is cost-ineffective. Therefore, the patent fails to compete with others in mass production, and thus cannot meet the requirement for the market.

U.S. Pat. No. 4,605,167 discloses an ultrasonic spraying device designed to increase an atomizing area by increasing a spraying area of nozzle apertures. Despite an increase in the atomizing area, an increase in the spraying area of the nozzle apertures entails using different piezoelectric operating frequencies, such that energy consumption required to actuate the device is also increased and a drawback occurs, that is, bulkiness. Additionally, such technique is still unable to solve the problem of the accumulation of atomized liquid droplets.

U.S. Pat. No. 6,089,698 discloses a method and a device for forming nozzle apertures. Referring to the method for forming the nozzle apertures, laser beams with high energy are used to form the nozzle apertures on a surface of a nozzle plate, so as to control the spraying direction of liquid droplets. The method which involves forming the nozzle apertures by means of the laser beam is complicated and does not meet the requirement for the industrial applications. Furthermore, as liquid droplets are expelled in a perpendicular direction in accordance with the prior art, problems such as a narrow atomizing area and a poor atomization effect cannot be solved.

U.S. Pat. No. 6,235,177 has also disclosed a method for forming a spraying device. As a nozzle aperture having an upper surface and a lower surface with a converging shape is formed, liquid droplets can be instantly expelled along a central axis of the nozzle aperture. In the prior art, the nozzle apertures of the spraying device is designed to be symmetric structures, such that the spraying area is restricted to the location and the distribution area of the nozzle apertures. Therefore, the drawbacks of the foregoing patents cannot be eliminated, resulting in a poor atomization effect.

As the foregoing liquid atomizing techniques have disadvantages including atomized liquid droplets being expelled in a perpendicular direction, an atomizing area limited to a distribution area of nozzle apertures, droplet accumulation due to convergent spraying, relatively large volume and complicated fabrication methods, a poor atomization effect is resulted and energy is wasted. Additionally, it is difficult to miniaturize the product and requirements cannot be met for industrial applications.

What is needed, therefore, is to provide a spraying device to effectively solve the foregoing problems facing the prior art.

### SUMMARY OF THE INVENTION

In light of the above drawbacks of the prior art, a primary objective of the present invention is to provide a spraying device so as to increase an atomizing area.

Another objective of the present invention is to provide a spraying device whereby homogenized atomized liquid droplets can be formed.

Still another objective of the present invention is to provide a spraying device so as to miniaturize a product.

A further objective of the present invention is to provide a spraying device which is energy-saving.

A further objective of the present invention is to provide a spraying device for use with a simple fabrication method.

In accordance with the foregoing and other objectives, the present invention proposes a spraying device for atomizing a liquid. The spraying device comprises a nozzle plate having a plurality of nozzle apertures, wherein each of the nozzle apertures comprises an entry end for the liquid to enter and an exit end for the liquid to exit, and the entry end and the exit end of at least one of the nozzle apertures are asymmetrical structures, such that a tilting predetermined angle of the liquid can be controlled to expel the liquid; and an actuator mounted on the nozzle plate for actuating the atomization of the liquid.

Preferably, the nozzle plate can be an electrocast nozzle plate, a metal nozzle plate, or a non-metal nozzle plate. In a preferred embodiment, the nozzle apertures (the first nozzle apertures) are aligned in an array, and the entry end and the exit end of each of the nozzle apertures are asymmetric structures. In another preferred embodiment, the nozzle apertures are aligned in a ring pattern. In other embodiments, the nozzle apertures can be aligned in both an array and a ring pattern. Such modification is known and can be easily achieved by one skilled in the pertinent art according to practical requirements. Thus, the alignment of the nozzle apertures is not limited to the aforesaid array or ring pattern.

Moreover, the entry end has a volcanic cone shape while the exit end has a meniscus shape. In a preferred embodiment, the exit end points toward an inner portion of the nozzle plate. In another preferred embodiment, the exit end points toward an outer portion of the nozzle plate.

The nozzle plate of the spray device can further comprise at least a nozzle aperture (a second nozzle aperture) having an entry end and an exit end which are symmetric structures, such that the liquid can be expelled in a perpendicular direction, wherein the entry end and the exit end both have volcanic cone shapes. In a preferred embodiment, the nozzle apertures are aligned in an array. In another preferred embodiment, the nozzle apertures are aligned in a ring pattern. In other embodiments, the nozzle apertures can be aligned in both an array and a ring pattern. Thus, the alignment of the nozzle apertures is not limited to the aforesaid array or ring pattern.

The actuator can be a piezoelectric actuator, wherein the piezoelectric actuator can be preferably a piezoelectric ring.

In comparison to the prior art, the present invention proposes a spraying device having a planar nozzle plate. The geometric shape of the exit end of more than one nozzle aperture of the nozzle plate is designed as a thin plate which allows the liquid to be expelled from the nozzle aperture via a tilting predetermined angel. Such geometric design and the distribution of the nozzle apertures of the nozzle plate are able to achieve a divergent spraying effect when the nozzle plate is actuated by the actuator. Also, a spraying direction of a liquid droplet after the liquid is atomized can be controlled, such that the liquid droplets are expelled in a converging manner or in a diverging manner for increasing a spraying area. Thus, problems facing the prior art, including atomized liquid droplets being expelled in a perpendicular direction, an atomizing area limited to a distribution area of a nozzle aperture, and droplet accumulation due to convergent spraying, can be solved. Therefore, the present invention can be applied to atomization of a liquid in biomedical science, such that accumulation of atomized liquid droplets can be prevented to improve the homogeneity of the atomized liquid droplets. Also, it can be applied to a cooling system, such that a cooling mechanism can be operated effectively and consistently by increasing an atomizing area. Furthermore, it can also be applied to a drug delivery system, a fuel supplying system or other systems requiring sufficient liquid atomization.

Moreover, the present invention is able to increase the atomizing area within the same area unit, so as to achieve the best atomization effect using the least amount of energy within a limited volume. Unlike the prior art, the present invention discloses that both a distribution area of nozzle apertures and an actuating frequency need not be modulated correspondingly to modify the atomizing area. Therefore, drawbacks, such as an increase in the volume of the system, high resonance form required for large-scale actuation, and great energy consumption, can be eliminated. As the method for fabricating the nozzle apertures proposed in the present invention is simple, the problem of a high production cost caused by a complicated known fabrication method can be solved, such that the present invention is able to compete with others in mass production. In addition, the spraying device proposed in the present invention meets the market demand.

Accordingly, referring to the spraying device proposed in the present invention, the geometric design and the overall distribution of the nozzle apertures are able to increase the atomizing area, provide homogenized atomized liquid droplets, miniaturize the product, consume less energy and simplify the fabrication method, so as to solve the problems facing the prior art.

The present invention is described in the following with specific embodiments, so that one skilled in the pertinent art can easily understand other advantages and effects of the present invention from the disclosure of the invention. The present invention may also be implemented and applied according to other embodiments, and the details may be modified based on different views and applications without departing from the spirit of the invention.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram showing a spraying device according to the first preferred embodiment of the present invention;

FIG. 2a and FIG. 2b are schematic diagrams showing some nozzle apertures of a spraying device according to the first preferred embodiment of the present invention, wherein FIG. 2b is a schematic diagram showing partial enlargement of FIG. 2a;

FIG. 3a to FIG. 3c are schematic diagrams showing a spraying direction of a liquid being expelled from a nozzle aperture, wherein FIG. 3a is a schematic diagram showing atomization of a liquid due to resonance of the liquid caused by an actuator, FIG. 3b is a schematic diagram showing that the liquid is tilted at a specific angle in order to be expelled from the nozzle aperture, and FIG. 3c is a schematic diagram showing the distribution of the nozzle apertures;

FIG. 4 is a partial schematic diagram showing the distribution of nozzle apertures shown in FIG. 1;

FIG. 5 is a schematic diagram showing a spraying device according to the second preferred embodiment of the present invention;

FIG. 6 is a schematic diagram showing a spraying device according to the third preferred embodiment of the present invention;

FIG. 7 (PRIOR ART) is a schematic diagram showing a conventional spraying device; and

FIG. 8a to FIG. 8c are schematic diagrams showing a spraying direction of a liquid being expelled from a nozzle aperture as shown in FIG. 7, wherein FIG. 8a is a schematic diagram showing atomization of a liquid due to resonance of the liquid caused by an actuator, FIG. 8b is a schematic diagram showing that the liquid is expelled from the nozzle aperture in a perpendicular direction, and FIG. 8c is a schematic diagram showing the distribution of the nozzle apertures.

### DETAILED DESCRIPTION OF THE EMBODIMENTS

The following embodiment only serves to provide further description for the present invention with no intent to limit the scope of the invention. An important point to note is that only basic structures of a spraying device are illustrated in the following embodiments. The spraying device can be provided with additional elements according to an atomizing system, such as a drug delivery system in a spraying device, a fuel-injection atomizing system, and a heat dissipating cooling system or other systems requiring sufficient liquid atomization, and thus is not limited by what described in the following embodiments.

An important point to note is that these drawings are simplified schematic diagrams, and thus only structures relevant to the present invention are illustrated. Also, these structures are not drawn according to actual amounts, shapes and dimensions. Actually, quantity, shape and dimensions belong to a matter of design and the arrangements of the structures may be very complex in practice.

### The First Preferred Embodiment

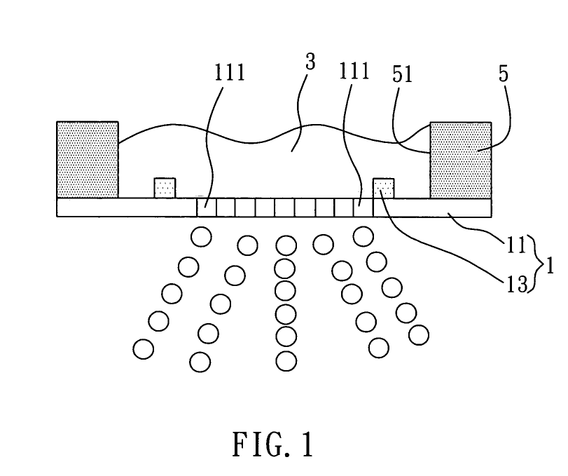

FIG. 1 to FIG. 4 are schematic diagrams showing a spraying device according to the first preferred embodiment of the present invention.

FIG. 1 is a schematic diagram showing a spraying device 1 according to the present invention. The spraying device 1 is used to atomize a liquid 3 and at least comprises a nozzle plate 11 and an actuator 13. The liquid 3 to be atomized is contained in a liquid chamber 51 of a container 5. Also, the spraying device 1 flanks the liquid chamber 51. Another noteworthy point is that the spraying device proposed in the present invention can be modified in terms of allocation, and/or other elements are introduced, and thus the present invention is not limited to the present embodiment.

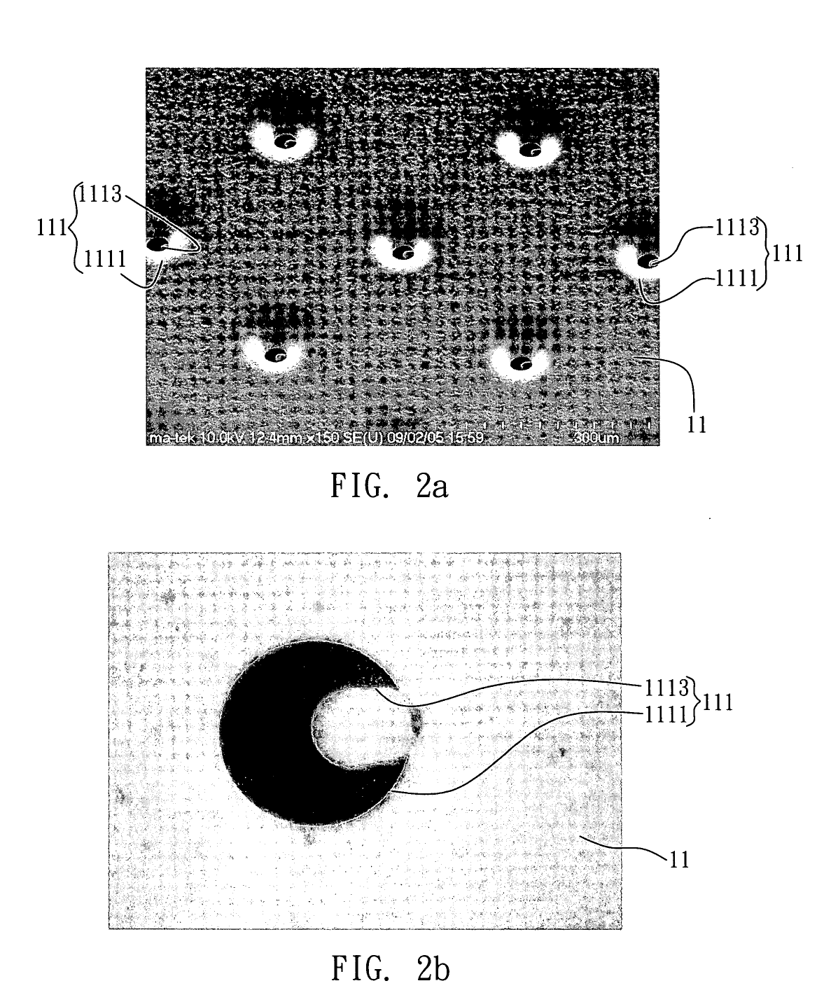

Referring to FIG. 1, the nozzle plate 11 is formed with a plurality of first nozzle apertures 111. Referring to FIG. 2a and FIG. 2b, each of the first nozzle apertures 111 comprises an entry end 1111 for the liquid 3 to enter and an exit end 1113 for the liquid 3 to exit. Also, the entry end 1111 and the exit end 1113 of each of the first nozzle apertures 111 are asymmetrical structures, such that a tilting predetermined angle of the liquid 3 can be controlled in order to expel the liquid 3. In the present embodiment, the first nozzle apertures 111 are aligned in a ring pattern. The entry end 1111 with a volcanic cone shape is equivalent to a convergent opening structure. The exit end 1113 has a meniscus shape, and the exit end 1113 points toward an inner portion of the nozzle plate 11, such that liquid droplets can be expelled in a diverging manner.

The nozzle plate 11 can be an electrocast nozzle plate formed by an electrocasting method, wherein a pattern of the nozzle plate 11 is defined by a lithography process, for example. The nozzle plate 11 comprises the first nozzle apertures 111 each having the exit end 1113 with a meniscus shape. In other words, the exit end 1113 is designed as a meniscus thin plate. Also, the entry end 1111 for the liquid 3 to enter is designed to have a volcanic cone shape as usual. Therefore, when the liquid 3 is expelled from the first nozzle aperture 111, the liquid 3 is expelled in a direction pointed by the meniscus shape. By such arrangement, the exit end of the conventional nozzle aperture which has a circular shape can be provided with a protruded plate structure. In other words, the exit end of the present invention can be designed to have a meniscus shape to control a spraying direction of an atomized liquid droplet while the entry end still has a volcanic cone shape to ease the flow of the liquid.

The fabrication method of the nozzle plate 11 proposed in the present invention is not limited by the present embodiment. Alternatively, it can be a metal nozzle plate fabricated by mechanical methods or other nozzle plates fabricated using other appropriate methods, provided that the fabrication method is simplified. Also, the foregoing fabrication methods are known in the pertinent art, and thus will not be further described.

The actuator 13 is mounted on the nozzle plate 11 for actuating the atomization of the liquid 3. In the present embodiment, the actuator 13 can be a piezoelectric actuator which is characterized by a perfect piezoelectric property and made of a material such as a lead zirconate titanate (PZT) solid-solution. Once power is supplied to the actuator 13, oscillation kinetic energy can be generated by a piezoelectric effect. As the piezoelectric effect of the piezoelectric actuator can be easily understood by one ordinarily skilled in the pertinent art and is not the main technical feature of the present invention, it will not be further described herein.

Furthermore, the piezoelectric actuator can be a piezoelectric ring, a piezoelectric plate or an element made of a piezoelectric material. As the piezoelectric material having electromechanical couple is characterized by low weight, small volume and a fast response, and is able to produce a greater displacement when being actuated by a low voltage input, it can be selected as an appropriate material for fabricating the actuator. However, the actuator of the present invention is not limited to the piezoelectric material.

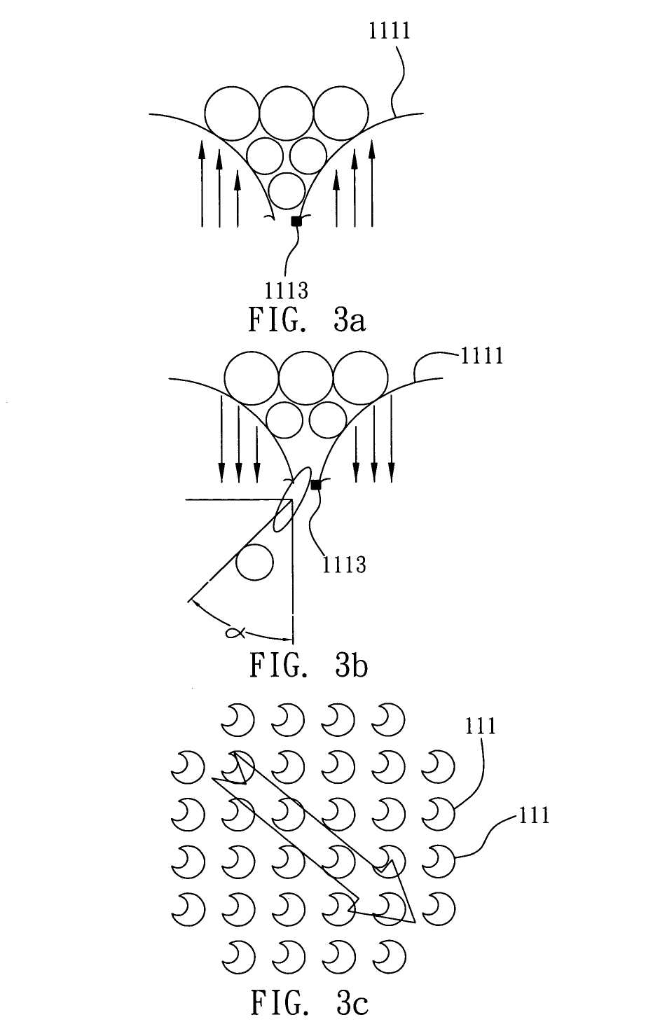

When the liquid 3 is to be atomized, the actuator 13 actuates the resonance of the liquid 3, so as to atomize the liquid 3 as shown in FIG. 3a. Referring to FIG. 3b, the liquid 3 is expelled from the first nozzle aperture 111 via a tilting angle α. Referring to FIG. 3c, the liquid 3 is sprayed in a direction pointed by the meniscus shape. Therefore, liquid droplets are expelled in a diverging manner, so as to increase an atomizing area. An important point to note is that the angle α in the present embodiment is calculated according to an axis and a center of the liquid, and can be a 45° angle but is not limited by the present embodiment. The angle α can be modified by one skilled in the pertinent art depending on practical requirements, so as to modify the tilting angle for the liquid droplet to be expelled outward.

Referring to FIG. 4, the nozzle plate 11 can further comprise second nozzle apertures 113 each having an entry end (not shown) and an exit end 1133 which are symmetric structures. In the present embodiment, the entry end has a volcanic cone shape while the exit end 1133 has a circular shape. Thus, liquid droplets can be expelled in a perpendicular direction. In the present embodiment, the first nozzle apertures 111 and the second nozzle apertures 113 are aligned in a ring pattern. However, an important point to note is that these allocations can be modified by one skilled in the pertinent art in other embodiments, and are not limited by the present embodiment.

According to the spraying device 1 in the present embodiment, the spraying device 1 proposed in the present invention is designed with a planar nozzle plate 11 having at least one first nozzle aperture 111 and at least one second nozzle aperture 113. The geometric design and the distribution of the first nozzle apertures 111 and the second nozzle apertures 113 allow some of the atomized liquid 3 to be expelled from the first nozzle apertures 111 at a specific tilting angle and allow some of the atomized liquid 3 to be expelled from the second nozzle apertures 113 in a perpendicular direction when actuated by the actuator 13, so as to achieve a divergent spraying effect. Therefore, the atomizing area can be increased and homogenized atomized liquid droplets can be obtained. Further, as the spraying device 1 proposed in the present invention is able to increase the atomizing area within the same distribution area of the nozzle apertures, the product can be miniaturized,.not to mention that no extra energy is consumed.

In comparison to the prior art whereby the nozzle apertures of the nozzle plate are designed to have symmetric structures, the present invention is able to control a spraying direction of an atomized liquid droplet as the spraying direction is limited by the geometric shape of the nozzle aperture when the liquid is expelled from the nozzle aperture. Also, the nozzle apertures are distributed in a ring pattern to control the atomizing area, such that the liquid droplets can be expelled in a converging manner or in a diverging manner so as to increase a spraying area. Thus, the atomizing area can be increased to efficiently prevent collision of the atomized liquid droplets. Therefore, the spraying device proposed in the present invention is characterized by a simple fabrication method and is able to effectively increase the atomizing area. Moreover, the present invention prevents the atomized liquid droplets from colliding with each other, but does not increase the volume of the system or energy consumption.

### The Second Preferred Embodiment

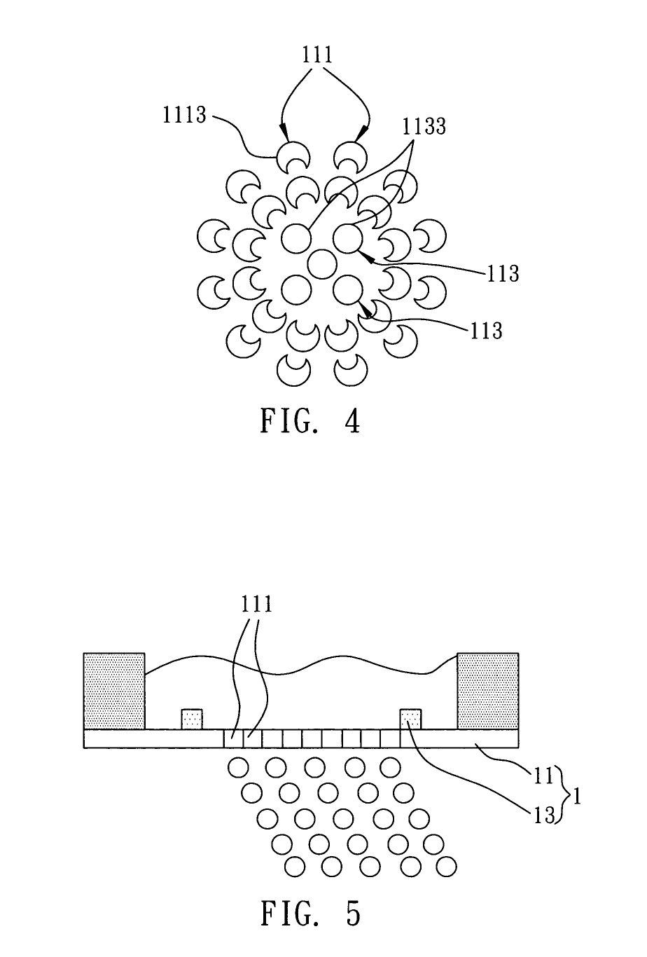

FIG. 5 is a schematic diagram showing a spraying device according to the second preferred embodiment of the present invention. In order to articulate the present invention more easily, any elements consistent with or similar to those in the first preferred embodiment are denoted by the consistent or similar symbols and will not be described herein in detail.

The second preferred embodiment differs from the first preferred embodiment in that the spraying device is able to expel the liquid from the nozzle aperture at a tilting angle.

Referring to FIG. 5, a spraying device 1 at least comprises a nozzle plate 11 and an actuator 13. What differs from the first preferred embodiment is that the nozzle plate 11 is only formed with a plurality of first nozzle apertures 111. In other words, entry ends 1111 and exit ends 1113 of all of the first nozzle apertures 111 are asymmetric structures. Also, in the present embodiment, all of the first nozzle apertures 111 are aligned in the same direction. In other words, instead of a ring pattern as described in the first preferred embodiment, the first nozzle apertures 111 are aligned in an array. Thus, in the present embodiment, the liquid 3 can be expelled from the first nozzle apertures 111 via a tilting angle. The allocation of the first nozzle apertures 111 is shown in FIG. 3c and will not be further illustrated.

Accordingly, the spraying device proposed in the present invention is able to control a spraying direction of an atomized liquid, so as to effectively control an atomizing area.

### The Third Preferred Embodiment

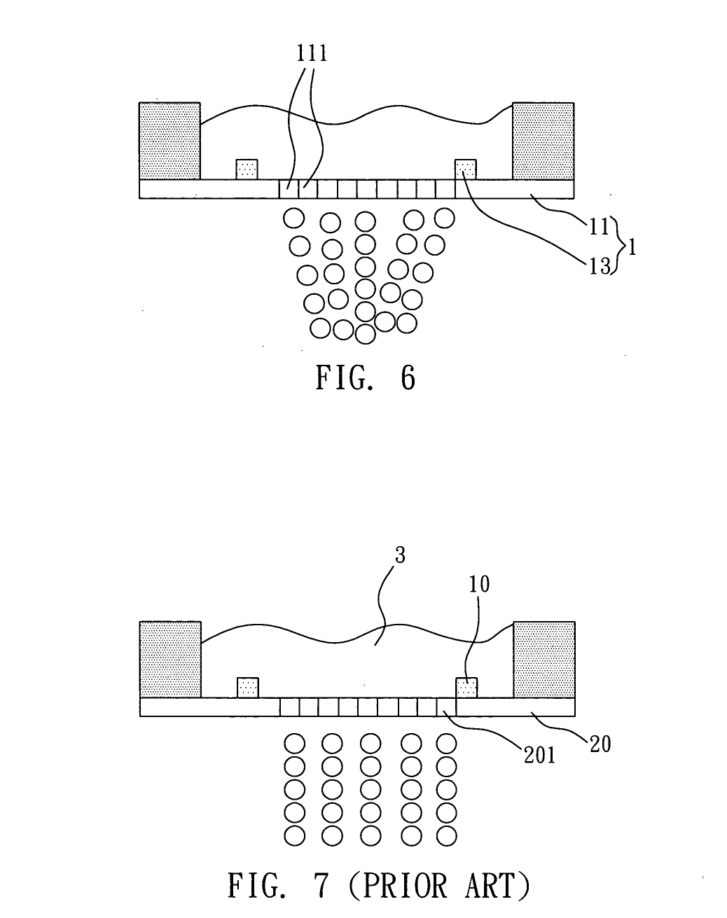

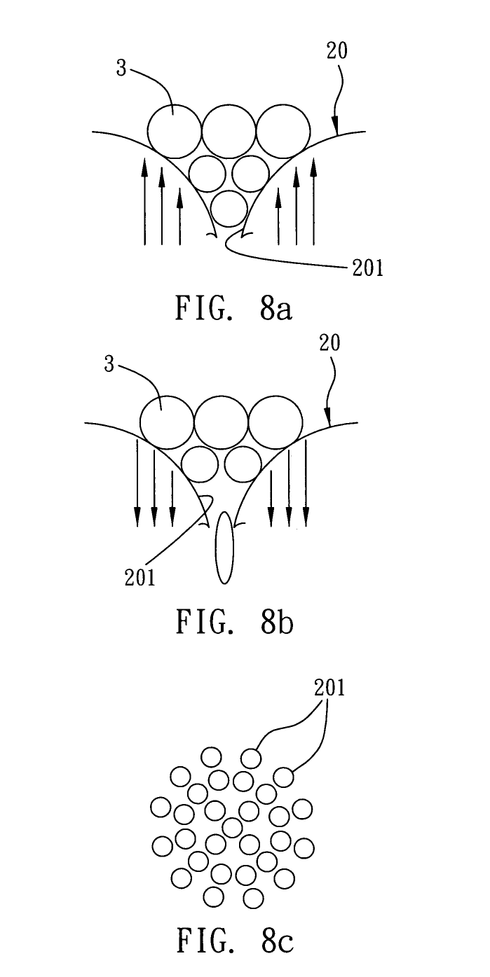

FIG. 6 is a schematic diagram showing a spraying device according to the third preferred embodiment of the present invention. In order to articulate the present invention more easily, any elements consistent with or similar to those in the foregoing embodiments are denoted with the consistent or similar symbols and will not be described herein in detail.

The third preferred embodiment differs from the first preferred embodiment and the second preferred embodiment in that the spraying device is able to expel the liquid in a converging manner.

Referring to FIG. 6, the spraying device 1 at least comprises the nozzle plate 11 and the actuator 13. What differs from the first preferred embodiment is that the nozzle plate 11 is only formed with a plurality of first nozzle apertures 111. In other words, entry ends 1111 and exit ends 1113 of all of the first nozzle apertures 111 are asymmetric structures. Also, what differs from the first and the second embodiments is that the exit end 1113 having a meniscus shape points toward an outer portion of the nozzle plate, such that liquid droplets can be expelled in a converging manner.

The allocation of the first nozzle apertures 111 and the second nozzle apertures 113 can be easily modified by one skilled in the pertinent art to control the spraying direction of the atomized liquid. Also, the modification of the allocation of the first nozzle apertures 111 and the second nozzle apertures 113 is flexible. For example, the exit ends 1113 of the first nozzle apertures 111 of the nozzle plate 11 point toward an outer portion and an inner portion of the nozzle plate 11 respectively. Many examples of modification can be easily provided by one skilled in the pertinent art and thus will not be further illustrated.

The spraying device proposed in the present invention can be freely modified in terms of the allocation of the first nozzle apertures 111 and the second nozzle apertures 113 so as to set the spaying direction of the atomized liquid to convergence, divergence and/or a specific tilting angle, so as to effectively control and/or increase the atomizing area.

Accordingly, the present invention proposes a spraying device whose nozzle apertures are designed to have structures with one or more than one different shapes. The spraying direction of the liquid can be controlled according to the design and arrangement of the nozzle aperture. Thus, the present invention is able to easily modify the atomizing area within the same distribution area of the nozzle apertures depending on the modification of the structure of the nozzle apertures to meet the practical requirements. Therefore, the atomizing area of the liquid can be increased without increasing the distribution area of the nozzle apertures, so as to effectively achieve an atomization effect.

The geometric design and the overall distribution of the nozzle apertures increase the atomizing area and enable homogenized atomized liquid droplets. Also, the present invention increases the atomizing area of the liquid without increasing the distribution area of the nozzle apertures, so as to miniaturize the product without additional energy consumption. Moreover, as a pattern of the nozzle plate of the present invention can be defined by a lithography process and formed by an electrocasting method, or alternatively, by a mechanical method, a simplified fabrication method can be provided. Therefore, the present invention effectively controls the atomizing area, so as to increase the atomizing area, avoid accumulation of the atomized liquid droplets, prevent an increase in volume and a waste of energy, and provide a simple fabrication method. Therefore, the problems facing the prior art can be solved.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. A spraying device for atomizing a liquid, the spraying device comprising:
a nozzle plate having a plurality of nozzle apertures, wherein each of the nozzle apertures comprises an entry end for the liquid to enter and an exit end for the liquid to exit, and both the entry end and the exit end of at least one of the nozzle apertures are asymmetrical structures, such that a tilting predetermined angle of the liquid can be controlled to expel the liquid; and
an actuator integrated with the nozzle plate to actuate atomization of the liquid.

2. The spraying device of claim 1, wherein the nozzle plate is an electrocast nozzle plate.

3. The spraying device of claim 1, wherein the nozzle plate is a metal nozzle plate.

4. The spraying device of claim 1, wherein the nozzle plate is a non-metal nozzle plate.

5. The spraying device of claim 1, wherein the nozzle apertures are aligned in an array.

6. The spraying device of claim 1, wherein the nozzle apertures are aligned in a ring pattern.

7. The spraying device of claim 1, wherein the entry end has a volcanic cone shape.

8. The spraying device of claim 1, wherein the entry end has a volcanic cone shape and the exit end has a meniscus shape.

9. The spraying device of claim 8, wherein the exit end points toward an inner portion of the nozzle plate.

10. The spraying device of claim 8, wherein the exit end points toward an outer portion of the nozzle plate.

11. The spraying device of claim 1, further comprising nozzle apertures each having an entry end and an exit end, the entry end and the exit end being symmetric structures.

12. The spraying device of claim 1, wherein the entry end and the exit end both have volcanic cone shapes.

13. The spraying device of claim 1, wherein the actuator is a piezoelectric actuator.

14. The spraying device of claim 13, wherein the piezoelectric actuator is a piezoelectric ring.
